(19) United States
(12) Patent Application Publication
(10) Pub. No.: US 2018/0018444 A1
(43) Pub. Date: Jan. 18, 2018

(54) SYSTEM AND METHOD FOR USER NOTIFICATION OF IMAGING STATUS

(71) Applicant: Imaging Advantage LLC, Phoenix, AZ (US)

(72) Inventors: Kamil RAHME, Scottsdale, AZ (US); Shannon WEBER, Scottsdale, AZ (US)

(73) Assignee: Imaging Advantage LLC, Phoenix, AZ (US)

(21) Appl. No.: 15/652,183

(22) Filed: Jul. 17, 2017

Related U.S. Application Data
(60) Provisional application No. 62/362,916, filed on Jul. 15, 2016.
(60) Provisional application No. 62/362,930, filed on Jul. 15, 2016.

(51) Int. Cl. G06F 19/00; H04L 29/08

(52) U.S. Cl. CPC G06F 19/3487; H04L 67/12; G06F 19/321; H04L 67/1097

(57) ABSTRACT

Systems and methods are disclosed that notify a user of the status of his or her imaging, such as through the use of an application or website on a communication device. Some embodiments detect completion of an imaging appointment (e.g., for physiological imaging) and retrieve imaging data and a report analyzing the imaging data as they become available. This provides users with easy, seamless access to the status and results of their imaging as soon as possible.

### CROSS-REFERENCES TO RELATED APPLICATIONS

This application claims the benefit of U.S. Provisional Patent Application No. 62/362,916, filed Jul. 15, 2016, and is hereby incorporated by reference in its entirety. This application further claims the benefit of U.S. Provisional Patent Application No. 62/362,930, filed Jul. 15, 2016, and is hereby incorporated by reference in its entirety.

### BACKGROUND OF THE INVENTION

Facilities keep their own appointment schedules for imaging (e.g., physiological imaging). The appointment software may not be intelligent in the sense that it may not know what type of imaging is needed and the estimated duration of imaging appointments. Further, different facilities do not share their appointment schedules with other facilities. Thus, due to information deficiency and the amount of time and effort required to compare varying facilities, users (e.g., patients) may not have easy access to the cheapest, best, most accurate or most convenient facilities for imaging.

Facilities may implement a variety of imaging systems at imaging appointments, such as X-rays, CTs, MRIs, ultrasounds, and the like, to create images of users. These images may be combined with user information (e.g., name, date of birth, historical records, etc.) as well as imaging information (e.g., type of imaging, body location of imaging, name and location of facility, etc.) to create EMRs (electronic medical records). The EMRs may then be sent to image analysts, who may analyze and interpret the images. The analysts may generate an imaging report including analysis and information (e.g., findings, conclusions, analyst name, date and time of findings, comments, etc.) that may be forwarded back to the facilities for appropriate action.

After imaging appointments are completed and/or imaging reports are generated, some facilities provide users with a disc containing their imaging data. However, the users may not have the proper software to access and view the imaging data on the disc. Other facilities transmit the imaging data directly to the referring practitioners. In either case, the users have to wait for follow-up appointments with their referring practitioners to view the imaging data, which may be days or weeks later. Similarly, the users may have no access to report files interpreting their imaging data until their follow-up appointments. Current facilities may not have the technological capability to provide users with easy access to the status and results of their imaging.

### SUMMARY OF THE INVENTION

Thus, according to some embodiments of the invention, improved systems and devices for notifying users of their imaging status are provided. According to some embodiments of the invention, systems and methods are disclosed that notify a user of the status of his or her imaging (e.g., physiological imaging), such as through the use of an application or website on a communication device. Some embodiments described herein may detect completion of an imaging appointment and retrieve imaging data and a report file as they become available. This provides users with easy, seamless access to the status and results of their imaging as soon as possible.

According to some embodiments of the invention, a computer-implemented method is provided. The method comprises receiving, from a communication device at a first node on a network, a status request associated with a data record of a user. The data record includes a physiological image. The status request includes a source identifier and a plurality of metadata elements related to the physiological image. The method further comprises extracting the source identifier from the status request. The method further comprises querying a lookup table to identify a source server associated with the source identifier. The source server populates a database with a plurality of data records of a plurality of users. The method further comprises translating at least one metadata element of the plurality of metadata elements into a record identifier. The method further comprises establishing a data link with the source server at a second node on the network. The method further comprises querying the database of the source server for the data record of the user using the record identifier. The method further comprises transmitting a status indication of the data record of the user over the network.

According to some embodiments of the invention, a device is provided. The device comprises a processor and a memory coupled to the processor. The memory stores instructions, which when executed by the processor, cause the device to perform operations including the steps of the above method.

According to some embodiments of the invention, a computer-program product is provided. The computer-program product is tangibly embodied in a non-transitory machine-readable storage medium of a computing device, including instructions that, when executed by one or more processors, cause the one or more processors to perform operations including the steps of the above method.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparently upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a system diagram illustrating an imaging status and appointment request system according to some embodiments of the invention.

FIG. 2 is a system diagram illustrating an imaging distribution system according to some embodiments of the invention.

FIG. 3 is a system diagram illustrating a care system according to some embodiments of the invention.

FIG. 4 is a system diagram illustrating a filter applied to facilities according to some embodiments of the invention.

FIG. 5 is a flow chart illustrating a method for user-initiated imaging appointments according to some embodiments of the invention.

FIG. 6 is a flow chart illustrating a method for user-initiated imaging appointments according to some embodiments of the invention.

FIG. 7 is a screen shot of a graphical user interface for user-initiated imaging appointments according to some embodiments of the invention.

FIG. 8 is a screen shot of a graphical user interface for user-initiated imaging appointments according to some embodiments of the invention.

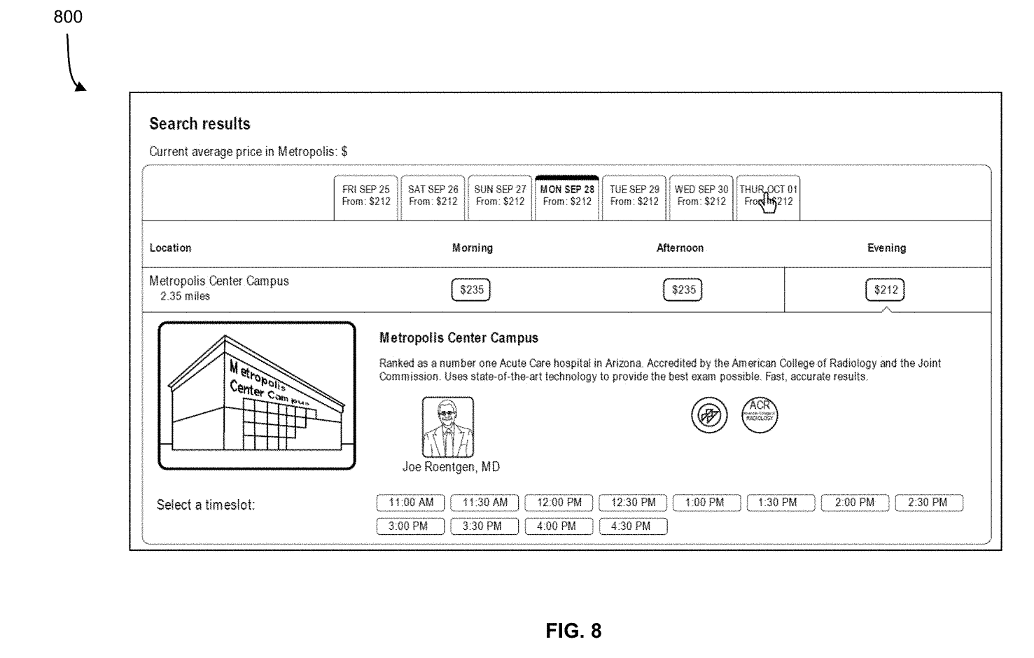

FIG. 9 is a flow chart illustrating a method for user notification of imaging status according to some embodiments of the invention.

FIG. 10 is a flow chart illustrating a method for user notification of imaging status according to some embodiments of the invention.

FIG. 11 is a screen shot of a graphical user interface for user notification of imaging status according to some embodiments of the invention.

FIG. 12 is an architectural diagram illustrating the functional layers of a communication device according to some embodiments of the invention.

### DETAILED DESCRIPTION OF THE INVENTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

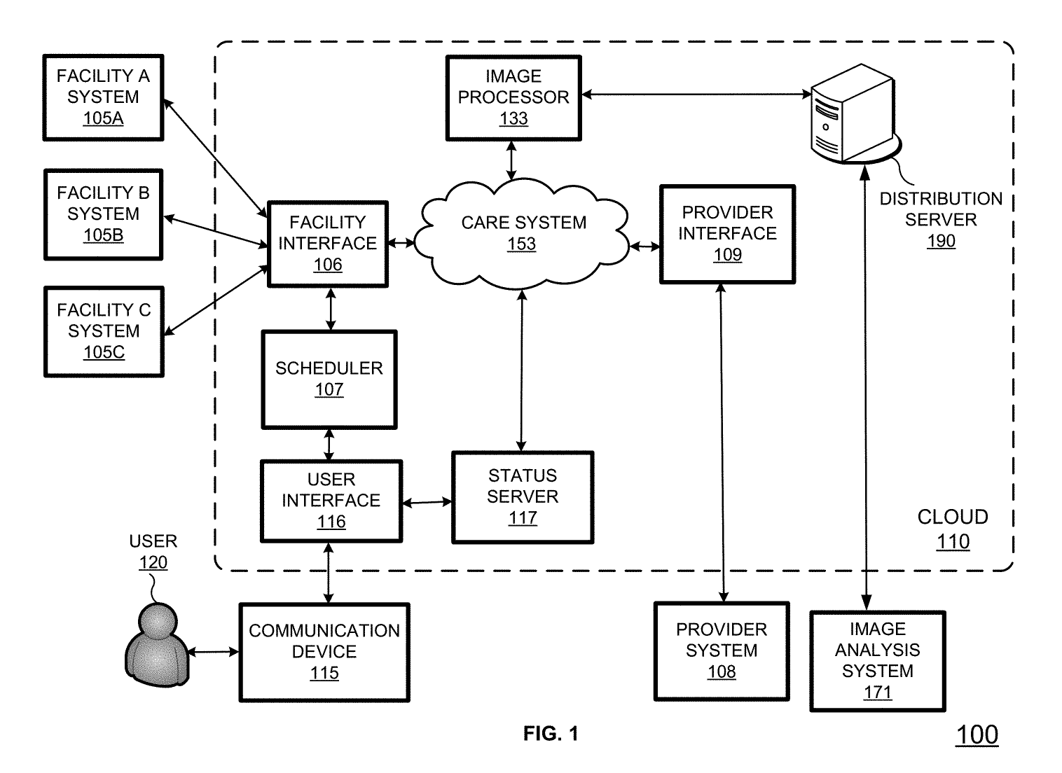

FIG. 1 illustrates a system 100 for generating and distributing EMRs that include imaging (e.g., physiological imaging) and imaging reports. System 100 includes user 120 operating a communication device 115, facility systems A-C 105A-C associated with imaging facilities, provider system 108 associated with a care provider (e.g., a practitioner referring user 120 for imaging), an image analysis system 171 associated with an image analyst (e.g., a practitioner interpreting the imaging and generating a report file), and a number of components within cloud 110. Cloud 110 includes user interface 116, scheduler 107, facility interface 106, care system 153, status server 117, image processor 133, provider interface 109, and distribution server 190.

In the illustrated embodiment, user 120 may use communication device 115 to access a user interface 116. In some embodiments, user 120 may be any user performing operations related to imaging appointments and/or imaging as a user or on behalf of a user. For example, user 120 may be a patient, a parent, child, friend, family member, power of attorney, nurse, or any other care giver acting on behalf of a patient.

A “communication device”, such as communication device 115, may comprise any suitable electronic device that may be operated by a user, such as a computer, and that provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of communication devices include mobile devices (e.g., cellular phones), PDAs, tablet computers, net books, laptop computers, personal music players, handheld specialized readers, watches, fitness bands, ankle bracelets, rings, earrings, etc., as well as automobiles with remote communication capabilities. A communication device may comprise any suitable hardware and software for performing such functions, and may also include multiple devices or components (e.g., when a device has remote access to a network by tethering to another device—i.e., using the other device as a modem—both devices taken together may be considered a single communication device).

User interface 116 may be, for example, an application server associated with an application executing on communication device 115, and may be located in cloud 110. User interface 116 is networked to a scheduler 107. Scheduler 107 may aggregate and allow access to imaging appointment schedules for a plurality of imaging facilities, such as facility systems A-C 105A-C. Facility systems A-C 105A-C may communicate their available appointment schedules to scheduler 107 through a facility interface 106. Scheduler 107 may allow a user, via user interface 116, to view booked appointment(s) with one or more imaging facilities. The booked appointment(s) associated with the user may be stored in a datastore associated with scheduler 107. For example, booked appointment(s) may be stored in a profile associated with a particular user in conjunction with a unique user identifier. The identifier may be any combination of letters, numbers, and/or symbols, and/or may include the user's name, birthdate, address, and/or any other identifying information, or may be randomly chosen or generated.

Facility systems A-C 105A-C may be associated with imaging facilities that perform imaging of users and generate imaging data. For example, facility systems A-C 105A-C may each contain any number of imaging devices (e.g., physiological imaging devices), such as X-ray devices, MRI devices, CT scan devices, ultrasound devices, mammogram devices, and the like. In one example, user 120 may visit an imaging facility associated with facility system A 105A to have imaging data taken with an imaging device located at that imaging facility. The imaging facility may store the generated imaging data for user 120 on facility A system 105A, which may then upload the imaging data to care system 153 via a facility interface 106. Although shown and described as having three facility systems 105A-C, it is contemplated that any number of facility systems may be in communication with facility interface 106.

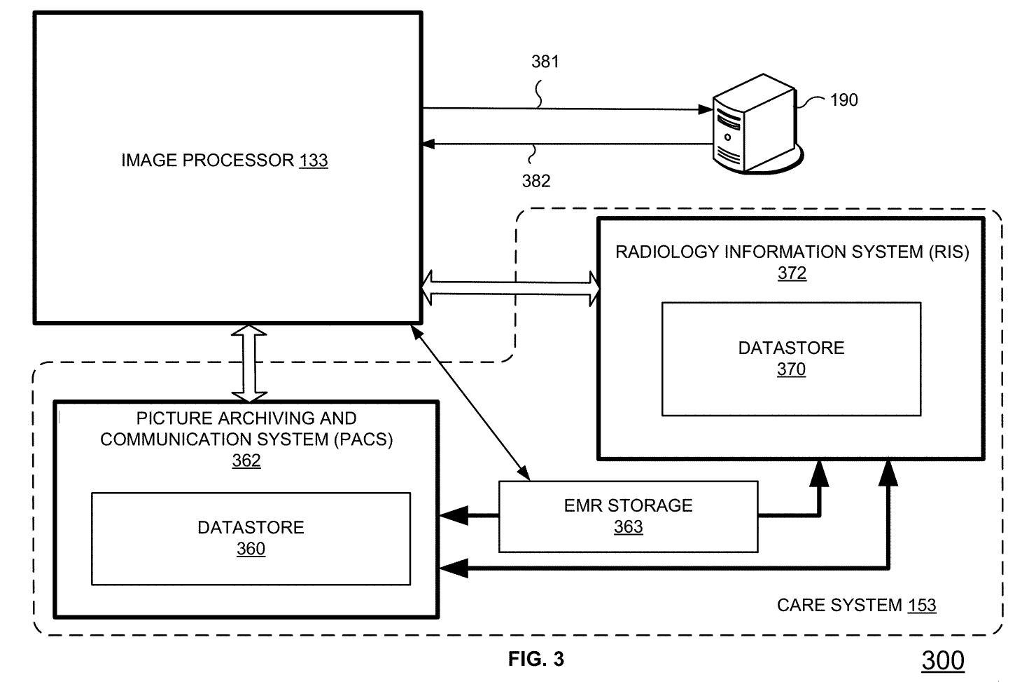

Once stored in care system 153, the imaging data may be retrieved by or otherwise sent to image processor 133. Image processor 133 may perform any of a number of operations on the imaging data, as described further herein with respect to FIG. 3. For example, image processor 133 may modify, resize, reformat, filter, zoom, crop, and/or enhance the imaging data for viewing and use by a user. Image processor 133 may then store the modified imaging data back in care system 153. In some embodiments, however, no modification of the imaging data may be necessary.

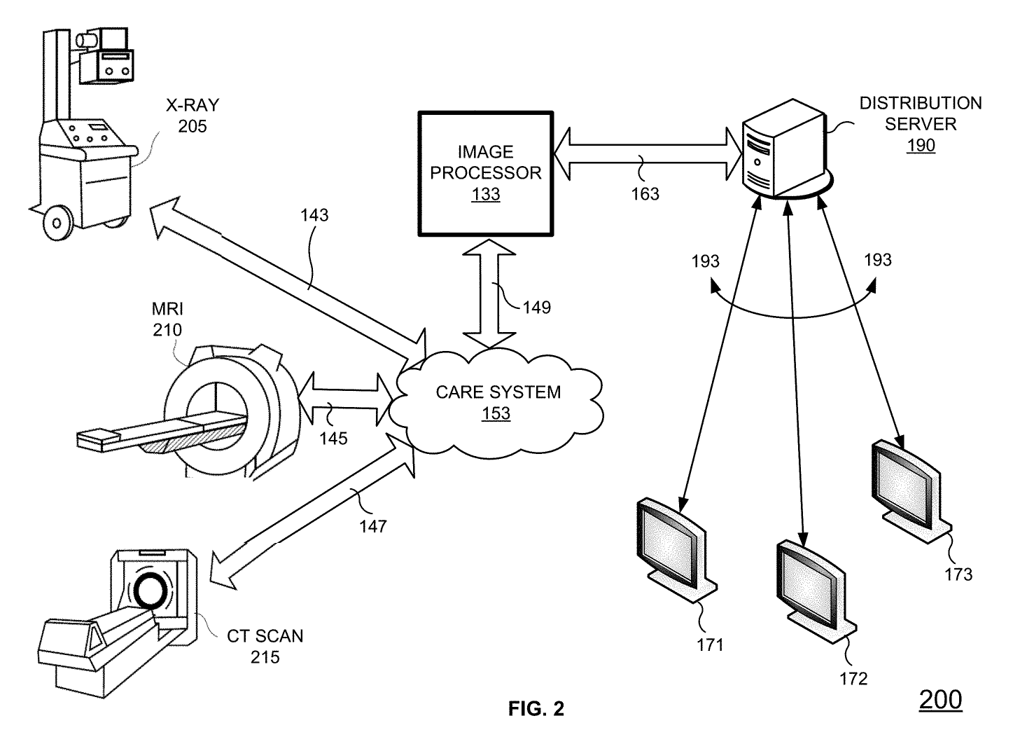

Image processor 133 may further transmit the imaging data to a distribution server 190. As described further herein with respect to FIG. 2, distribution server 190 may select an analyst from a plurality of image analysts to prepare the report file for the imaging data, based on any number of factors. In the example shown in FIG. 1, distribution server 190 has selected the image analyst associated with image analysis system 171. Thus, distribution server 190 transmits the imaging data to image analysis system 171.

The image analyst associated with image analysis system 171 may review the imaging data and generates a report file based on the imaging data. The report file (also referred to herein as an “imaging report”) may be a report interpreting the imaging data and may contain an analysis and/or conclusion based on the imaging data. For example, a report file for an X-ray may indicate that a user's left tibia is fractured. The report file is stored on image analysis system 171 and is transmitted back to distribution server 190. Distribution server 190 stores the report file in care system 153, either directly or through image processor 133 as illustrated.

User 120 may have access to data surrounding the imaging through user interface 116. For example, user 120 may be able to confirm his or her appointment and determine his or her appointment status (e.g., not yet started, in progress, completed) on communication device 115 via facility interface 106, scheduler 107, and user interface 116. User 120 may also have access to the status of the imaging data and/or the report file through an status server 117 in communication with user interface 116. In one embodiment, status server 117 may also provide user 120 with the imaging data and/or the report file via user interface 116 and communication device 115, as described further herein.

Access to the imaging data and/or report file may be provided to provider system 108 via a provider interface 109. Provider system 108 may be associated with a care provider of user 120, such as a practitioner that referred user 120 for the imaging. The care provider may review the report file and provide user 120 with any necessary follow-up care, such as the application of a cast, referral for surgery, referral for physical therapy, etc.

FIG. 2 illustrates a system 200 for distributing EMRs that include imaging, requests to generate imaging reports, and imaging reports. System 200 includes imaging devices. The imaging devices may include, but are not limited to, X-ray device 205, MRI device 210, and CT scan device 215. Other types of imaging devices (not shown) include ultrasound devices, endoscopy devices, elastography devices, tactile imaging devices, thermography devices, photography devices, nuclear medicine functional imaging devices (e.g., positron emission tomography (PET) devices, single-photo emission computed tomography (SPECT) devices, etc.), and/or the like. System 200 may also include care system 153, image processor 133, distribution server 190, and image analysis systems A-C 171-173.

In the illustrated embodiment, X-ray device 205 is networked to care system 153 via link 143. Similarly, MRI device 210 is networked to care system 153 via link 145 and CT scan device 215 is networked to care system 153 via link 147. Links 143, 145, 147 may include Ethernet connections, wireless connections, or any other suitable network and/or networking protocol. For example, links 143, 145, 147 may be implemented as part of a personal area network (PAN), a local area network (LAN), a metropolitan area network (MAN), a wide area network (WAN), a storage area network (SAN), an enterprise private network (EPN), a virtual private network (VPN), and/or the like. Links 143, 145, 147 may represent communication via any suitable network protocol, such as WiFi/WiMAX, Bluetooth, fibre channel network protocols, TCP/IP, OSI, SSH, SMB, FTP, SMTP, HTTP, HTTPs, SSL, SFTP, and/or the like.

Care system 153 may include a networked datastore suitable to store EMRs, imaging, user information, and the like, such as network-attached storage (NAS) or the like. Care system 153 may include, for example, EMR storage, a Picture Archiving and Communication System (PACS), a Radiology Information System (RIS), and/or the like, as discussed further herein. In some embodiments, care system 153 is a data storage server connected to a network that provides access to EMRs and other records by various parties. Care system 153 may provide access to EMRs and other records using network file sharing protocols such as Network File System (NFS) protocol, Server Message Block (SMB)/Common Internet File Systems (CIFS) protocol, Apple Filing Protocol (AFP), combinations thereof, and the like. Care system 153 may include redundant memory backups to ensure the integrity of the EMRs. The networked datastore may have terabytes of storage, for example. Care system 153 may include, for example, primary storage, secondary storage, tertiary storage, and/or offline storage. Care system 153 may further include processors, in some embodiments.

Image processor 133 is configured to access care system 153 and imaging stored in care system 153. Image processor 133 may be configured to read EMRs stored in care system 153 as well as write to EMRs stored in care system 153 via link 149. Link 149 may include Ethernet connections, wireless connections, or other suitable networking protocol that facilitates read/write access to the particular care system 153.

X-ray device 205, MRI device 210, CT scan device 215, care system 153, and image processor 133 may all be included in a same facility (i.e., imaging facility). Alternatively, the imaging devices may be in use at more than one facility while care system 153 is not co-located at the same physical site of the imaging devices. In other words, care system 153 may be located locally or remotely with respect to a facility. It is contemplated that more than one care system 153 may be implemented in some embodiments.

Image processor 133 is configured to access imaging files within care system 153 as well as certain data that is germane to analyzing imaging. Some data that is included in EMRs stored in care system 153 is not germane to imaging files. For example, a user's social security number is not necessarily useful in analyzing imaging. Image processor 133 may send imaging files and other data that is relevant to analyzing imaging to distribution server 190, via link 163.

Distribution server 190 may be a cloud server physically located at a datacenter in some embodiments. System 200 may include more than one distribution server 190 that are stored in different regional locales, for example. Image processor 133 may access the distribution server 190 that is within closest physical proximity to the image processor 133 in some embodiments. In some embodiments, image processor 133 may select a distribution server 190 according to some other criteria, such as network traffic as particular distribution servers 190.

In some embodiments, image processor 133 may generate a request (also referred to herein as an “order”) for an imaging report (also referred to herein as a “report file”). The imaging report may include at least one image file (also referred to herein as “imaging” and “imaging data”) and metadata. The metadata may include descriptors of the image file, the request, and/or the imaging report, such as user data (e.g., data associated with a user, such as a user name, a user date of birth, a user identifier, etc.), site data (e.g., data associated with the body site that is imaged in the image file), and modality data (e.g., data associated with the imaging device used to create the image file).

In some embodiments, distribution server 190 receives the images and other relevant data and generates a task to be put into a task list and/or a request for a report file. The task includes the images and other data that would be useful in analyzing the images and generating a report file analyzing the images. The task is assigned to an image analyst and then transferred to the image analysis system (e.g., 171, 172, or 173) used by the assigned analyst via one of network links 193. The distribution server 190 may assign the task to a certain analyst based on specialty (e.g., neurology, oncology, etc.), availability, a number of tasks already in a queue, or a variety of other factors.

The assigned analyst may generate a report file based on viewing the images and corresponding relevant data and send the report file back to distribution server 190, via link 193. Distribution server 190 may transmit the report file back to image processor 133. The report file may be in designated (e.g., standardized) format for efficient processing by image processor 133. Image processor 133 may store the report in care system 153 so that it is accessible for practitioners that have access to care system 153.

FIG. 3 illustrates a system 300 for distributing imaging records (e.g., images, EMRs, requests for image reports, imaging reports, etc.) that may include imaging. The system 300 may include an exemplary image processor 133 in communication with a distribution server 190 (also referred to herein as a “hub”). The system 300 may also include care system 153. Care system 153 may include, for example, a Picture Archiving and Communication System (PACS) 362, EMR storage 363, and/or a RIS 372. As appreciated by one skilled in the art, one, none or multiple of each of these components may exist in care system 153. For example, there may be one RIS 372 per imaging device (e.g., X-ray device, MRI device, etc.) at a given imaging facility, one PACS 362 per imaging facility, and/or one remote EMR storage 363 located in the cloud.

In use, the image processor 133 may receive imaging for a user from a RIS 372 of a particular imaging device, and/or from PACS 362 of a particular imaging facility. The imaging may be stored in datastore 360 of PACS 362 and/or datastore 370 of RIS 372. In another example, the image processor 133 may receive imaging for a user as part of an EMR stored in EMR storage 363. In some embodiments, PACS 362 and RIS 372 may have access to one another by a link to augment the respective records utilizing data from the other system.

In FIG. 3, image processor 133 may access Picture Archiving and Communication System (PACS) 362. PACS 362 may include a datastore 360. Also in FIG. 3, image processor 133 may access RIS 372. RIS 372 may include a datastore 370. Image processor 133 may utilize an Application Program Interface (API) that is specific to PACS 362 to interact with PACS 362 to access the imaging files stored as part of the PACS system. Similarly, EMR block 332 may utilize an API that is specific to RIS 372 to interact with RIS 372 to access the imaging files stored as part of the RIS system. In some embodiments, the EMRs may be stored in a local memory including in image processor 333.

Image processor 133 may have access to one or both of datastore 360 and datastore 370, depending on the specific EMR file configuration of the particular facility or organization. Some facilities utilize a PACS-centric system where PACS is the prominent EMR system and interactions with the EMR system utilize a PACS interface. Other facilities utilize a RIS-centric system where RIS is the prominent EMR system and interactions with the EMR system utilize a RIS interface. The data in datastore 360 and/or datastore 370 may be duplicated in care system 153, for example.

Once image processor 133 accesses the relevant EMR that includes imaging, the EMR may be filtered in some embodiments. The relevant EMR may be filtered by removing data that is not relevant to analyzing imaging and be included in imaging package 381. A user's social security number, emergency contact information, payment information, and other data items included in an EMR may not necessarily be useful in analyzing imaging, for example. However, a user's age and/or past events (e.g., surgeries) may be relevant to analyzing imaging, and therefore be included in imaging package 381 for sending to distribution server 190. Imaging package 381 may include a record identification number that identifies the user or file that the imaging package originates from.

After filtering, the filtered data may be formatted by image processor 133 in some embodiments. The filtered data may be normalized by ordering the filtered data into an efficient format of imaging package 381. Additionally, the imaging may be compressed for transmission. The compression is lossless compression, in one embodiment. Possible compression modes include JPLL (JPEG lossless), JLSL (JPEG-LS Lossless), J2KR (JPEG 2000 Lossless), and JPLY (JPEG Lossy).

The formatted data proceeds may be transmitted to distribution server 190 as imaging package 381. The imaging package 381 may be sent as a burst of packets that include the information of imaging package 381. Imaging package 381 includes the imaging (e.g., X-ray, CT scan, or MRI scan) to be analyzed by an image analyst as well as the information relevant to analyzing the imaging. The imaging package 381 may be formatted according to a format that is expected by distribution server 190. Imaging package 381 may include the imaging and EMR data that is related or relevant to analyzing the imaging.

As referenced above, distribution server 190 may receive the imaging package 381 and generates a task to be put into a task list. The task may include the imaging package 381. The task may be assigned to an image analyst and then transferred to the image analysis system (e.g., 171, 172, or 173) used by the assigned analyst via one of network links 193, as shown in FIG. 2. The assigned analyst may generate a report file based on viewing the images included in the task and send a report file 382 back to distribution server 190. Distribution server 190 may transmit report file 382 back to image processor 133. Report file 382 may include an identifier that identifies the user or file that the imaging packages originates from (e.g., a user or record identification number, a user name, a user data of birth, and/or the like). The report file 382 may be in a designated format for efficient processing by image processor 133, such as a standardized format. The report file 382 may be translated into a storing format that can be written back to the care system 153. Writing the translated report to the care system 153 may include accessing the identifier so that the correct user's EMR can be updated with the report from the image analyst. The identifier may be any combination of letters, numbers, graphics, and/or symbols.

Image processor 133, the components of care system 153, and/or distribution server 190 may use any suitable number of subsystems to facilitate the functions described herein. Such subsystems or components may be interconnected via a system bus. Subsystems may include a printer, keyboard, fixed disk (or other memory comprising computer readable media), display, which may be coupled to a display adapter, and others. Peripherals and input/output (I/O) devices, which may couple to an I/O controller, can be connected to the image processor 133, the components of care system 153, and/or distribution server 190 by any number of means. For example, an external interface can be used to connect the image processor 133, the components of care system 153, and/or distribution server 190 to a WAN such as the Internet, input device, or a scanner. The interconnection via the system bus may allow the central processor to communicate with each subsystem and to control the execution of instructions from system memory or the fixed disk, as well as the exchange of information between subsystems. The system memory and/or the fixed disk may embody a computer-readable medium.

The functions of image processor 133, the components of care system 153, and/or distribution server 190 described herein may be implemented as software code to be executed by a processor using any suitable computer language such as, for example, Java, C++, or Perl, using, for example, conventional or object-oriented techniques. The software code may be stored as a series of instructions or commands on a computer-readable medium, such as a random access memory (RAM), a read only memory (ROM), a magnetic medium such as a hard drive or a floppy disk, and/or an optical medium such as a CD-ROM. The computer readable medium may be any combination of such storage or transmission devices.

Such programs may also be encoded and transmitted using carrier signals adapted for transmission via wired, optical and/or wireless networks conforming to a variety of protocols, including the Internet. As such, a computer-readable medium according to an embodiment of the present invention may be created using a data signal encoded with such programs. Computer-readable media encoded with the program code may be packaged with a compatible device or provided separately from other devices (e.g., via Internet download). Any such computer-readable medium may reside on or within a single computer product (e.g., a hard drive a CD, or an entire computer system), and may be present on or within different computer products within a system or network. The systems may include a display for providing any of the results described herein to a user.

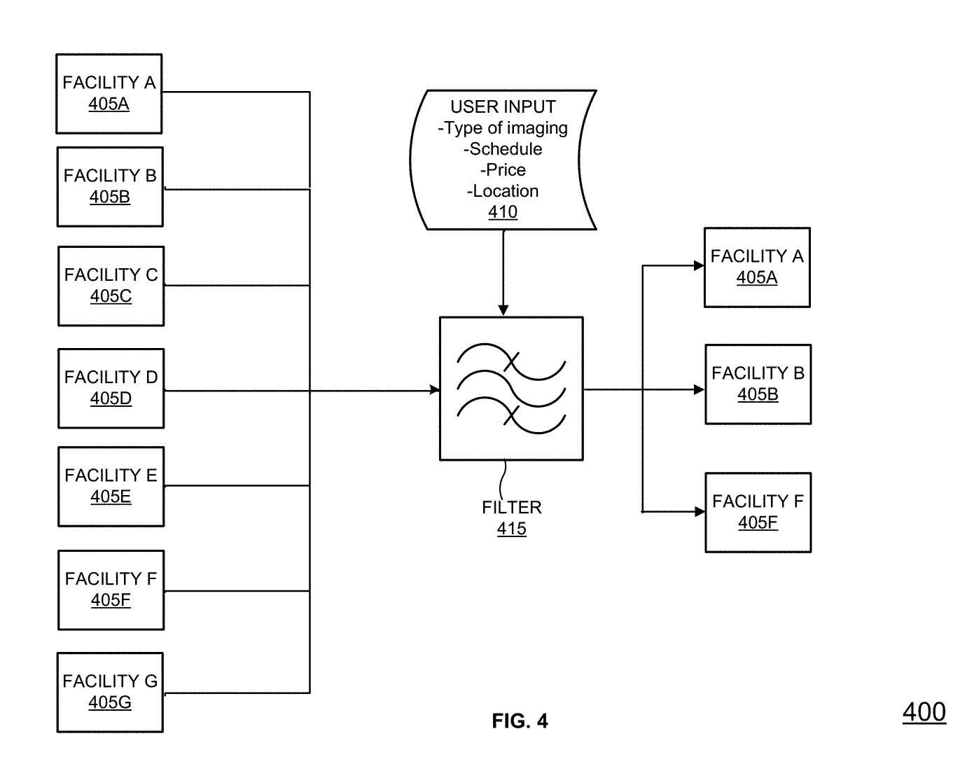

FIG. 4 depicts a system 400 for filtering imaging facilities for imaging appointments using user input. In the illustrated example, a plurality of facilities A-G 405A-G are input into a filter 415. Although illustrated and described as having seven facilities A-G 405A-G, it is contemplated that any number of imaging facilities may be input into filter 415.

Filter 415 may receive user input 410 specifying parameters for an imaging appointment. For example, user input 410 may specify a type of imaging needed (e.g., MRI), a bodily location of the imaging needed (e.g., brain), a schedule (e.g., date, day, and/or time), a price (e.g., a maximum price), a location (e.g., an imaging facility within a threshold distance of an input location), combinations thereof, and/or the like.

Filter 415 may apply the parameters to facilities A-G 405A-G and output the matching facilities. In this example, filter 415 located three imaging facilities that meet the parameters specified by user input 410: facility A 405A, facility B 405B, and facility F 405F. Although illustrated and described as having three matching facilities 405A, 405B, 405F, it is contemplated that any number of matching imaging facilities may be found. The matching facilities 405A, 405B, 405F may then be presented to the user providing user input 410 for further input and/or processing, as described further herein.

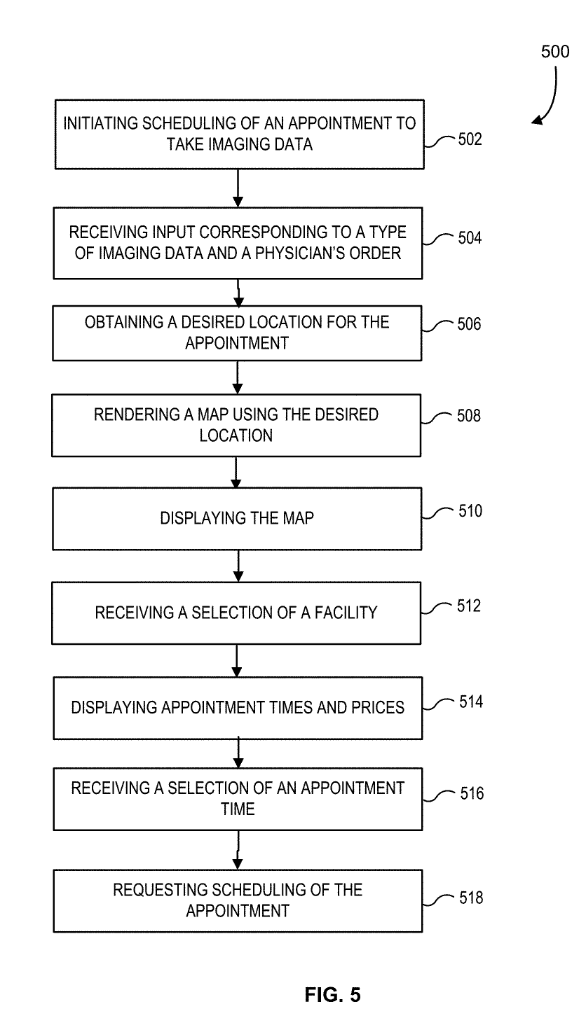

FIG. 5 depicts an illustrative flow chart for a process 500 for user-initiated imaging appointments. The process 500 is illustrated as a logical flow diagram, each operation of which represents a sequence of operations that can be implemented in either hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 500 (or any other processes described herein, or variations and/or combinations thereof) may be performed under the control of one or more computer systems configured with executable instructions and may be implemented as code (e.g., executable instructions, one or more computer programs or one or more applications). Network hardware and processing logic of communication device 115 may execute the process blocks show in process 500, for example. The code may be stored on a computer-readable storage medium, for example, in the form of a computer program including a plurality of instructions executable by one or more processors. The computer-readable storage medium may be non-transitory.

At process block 502, scheduling of an appointment is initiated, for example, via a web application or mobile application. The appointment may be an appointment to take imaging data. The imaging data will be taken during the appointment using at least one imaging device. The imaging device may include X-ray device 205, MRI device 210, or CT scan device 215, for example. With reference to FIG. 1, for example, user 120 may use communication device 115 to initiate scheduling of a imaging appointment using user interface 116. User interface 116 may act as a coordinator of scheduling the imaging appointment, and may be the provider of an application on communication device 115 having the functionality described herein, or a host of a website accessed on communication device 115 having the functionality described herein.

At process block 504, input is received corresponding to a type of imaging data and/or a practitioner's order for the imaging data. The input corresponding to the type of imaging data may be received together with or separate from the practitioner's order for the imaging data. In other words, the input may come from the same or from different entities or components.

For example, with reference to FIG. 1, a user 120 may initially input a type of imaging data needed into communication device 115, which may be transmitted to user interface 116. The type of imaging data needed may specify, for example, a type of imaging device (e.g., X-ray, CAT scan, bone scan, MRI, etc.) and a bodily location to be imaged (e.g., abdomen, right knee, head, etc.). The type of imaging data may be accompanied by an identifier of user 120, such as the user's name and date of birth. The type of imaging data may further be accompanied by other information, such as the name and/or contact information of the practitioner referring user 120 for the imaging.

In one embodiment, user interface 116 may use this accompanying information to locate a provider system 108 associated with the referring care provider, and to request and receive a practitioner's order for the imaging for the user 120. In another embodiment, the provider system 108 may automatically push the practitioner's order for the imaging to the user interface 116. In that embodiment, the user interface 116 may use the accompanying information used to initiate the imaging appointment request to match the practitioner's order to the correct user 120. In still another embodiment, the user 120 may provide the user interface 116 with the practitioner's order, such as by transmitting an image of the practitioner's order (e.g., taken with the communication device 115, scanned onto communication device 115, etc.).

Once the type of imaging data needed has been specified by the user 120, and the practitioner's order has been received, user interface 116 may verify that the information input by the user 120 is consistent with that specified by the practitioner's order in some embodiments. For example, user interface 116 may compare the type of imaging device and the location to be imaged as provided by the user 120 to the same data provided in the practitioner's order. In other embodiments, this verification may be performed by a remote system or server.

At process block 506, a desired location for the appointment is obtained. The desired location may be the same or different as the requesting user's current location. For example, the desired location may be obtained from a device used to initiate the request for the appointment, such as through a GPS function, or may be implied from the device's IP address. In another embodiment, the desired location may be manually entered as text or selected from a list or map by the user.

With reference to FIG. 1, communication device 115 may provide user interface 116 with the desired location for the imaging appointment. The desired location may be explicitly specified by the user 120 in one embodiment, such as by the user 120 entering the desired location (e.g., “Washington, D.C.” or “20001”) or selecting the desired location from a list or a map. In another embodiment, the desired location may be obtained from a Global Positioning System (GPS) device integrated in or operatively connected to the communication device 115. In some embodiments, the desired location may be obtained from an Internet Protocol (IP) address that communication device 115 used to access user interface 116.

User interface 116 may access scheduler 107 to identify facilities near or in the desired location that have available appointments for the type of imaging data needed. The type of imaging data needed may be extracted from the user input and/or the practitioner's order. In this embodiment, scheduler 107 has identified facility A (having facility A system 105A), facility B (having facility B system 105B), and facility C (having facility C system 105C), by communicating with their respective systems 105A-C. Although shown and described as identifying three facilities, A-C, it is contemplated that any number of facilities may be identified. Scheduler 107 may also obtain the prices for the available appointments from facilities A-C systems 105A-C. Scheduler 107 may be configured to communicate with many different types of facility computers, potentially implementing many different types of scheduling software.

Facilities A-C may all be near or in the desired location. For example, facilities A-C may all be within a threshold distance of the desired location (e.g., within 10 miles). This threshold distance may be selected according to any method, and may be modified according to any criteria (e.g., increased to 25 miles if there are no matching facilities within 10 miles).

Facilities A-C may also all have available appointments for the type of imaging data needed. For example, facilities A-C may each have the type of imaging device needed (e.g., MRI) that can be used for the location of the imaging (e.g., elbow). Further, facilities A-C may each have appointments available for the expected duration of the appointment to have that particular type of imaging data generated (e.g., 1 hour), as well as staff available to assist (e.g., an X-ray technician). In some embodiments, the expected duration of the appointment and/or the staff needed for the appointment can be determined automatically by user interface 116 without input from user 120 based on the type of imaging needed, the bodily location of the imaging, etc., as specified by user 120 and/or the practitioner's order. The appointments may be available within a specified time period, such as within the next 3 weeks.

At process block 508, a map may be rendered using the desired location. The map includes at least one facility and at least one price. Each of the at least one facility has at least one appointment time that is available to take the type of imaging data needed. In other words, facilities that do not have any available appointment times to take the type of imaging data needed are not displayed. The at least one price corresponds to a price for the at least one appointment time to take the type of imaging data needed at the at least one facility. In other words, the map may include one facility or a plurality of facilities, each having an associated price or range of prices for particular appointment times and a particular appointment type.

With reference to FIG. 1, user interface 116 may render a map using the desired location. The map may include facilities A-C at their respective locations. The map may further include a price (or range of prices) for available appointments at each of facilities A-C. User interface 116 may provide the map to communication device 115. In some embodiments, user interface 116 may instead forward the relevant information for facilities A-C to communication device 115, and communication device 115 may render the map.

At process block 510, the map, including the at least one facility and the at least one price, is displayed. With reference to FIG. 1, the map may be displayed on communication device 115. At process block 512, a selection of a facility from the at least one facility is received. The user may select the facility, for example, based on location (e.g., proximity to the desired location) and/or price. With reference to FIG. 1, user 120 may select a facility of facilities A-C from the map on communication device 115. For this example, assume that the user 120 selects facility A, associated with facility A system 105A.

At process block 514, the at least one appointment time for the selected facility and the at least one price for the at least one appointment time are displayed in response to the selection of the facility. For example, appointment times at the selected facility of Saturday, Jun. 11, 2016, at 11:00 AM (with a cost of $350); Monday, Jun. 13, 2016, at 8:15 AM (with a cost of $315); and Monday, Jun. 13, 2016, at 5:00 PM (with a cost of $315) may be displayed. Any number or combination of available appointment times at the selected facility may be displayed. For example, the first five available appointment times may be displayed, the cheapest five available appointment times may be displayed, etc.

With reference to FIG. 1, communication device 115 may then display the available appointment times for the type of imaging data needed to the user 120. In one embodiment, communication device 115 may first access a personal and/or business calendar stored on communication device 115, and may only display available appointment times in which user 120 is available according to his or her calendar. Communication device 115 may also display the associated price for each appointment time. Each appointment time may have the same or different associated prices. For example, X-rays during the week may be $400, while X-rays on the weekend may be $450, due to demand, less staff availability, etc.

At process block 516, a selection of an appointment time from the at least one appointment time is received. In the above example, the user may select the Monday, Jun. 13, 2016, 8:15 AM appointment time. At process block 518, scheduling of the appointment is requested. The request may include the selected appointment time, the cost, the type of imaging data, the selected facility, and/or user information.

With reference to FIG. 1, user 120 may select an appointment time from the available appointment times displayed on communication device 115. Communication device 115 may then transmit the selected facility (e.g., facility A) and the selected appointment time to user interface 116. User interface 116 may then transmit all of the relevant information needed to schedule the appointment to scheduler 107. Scheduler 107 may communicate with facility A system 105A via facility interface 106, in this example, to provide any information needed to schedule the appointment. In one embodiment, once the appointment is scheduled with facility A system 105A, scheduler 107 may generate an appointment confirmation to be transmitted back to communication device 115 via user interface 116.

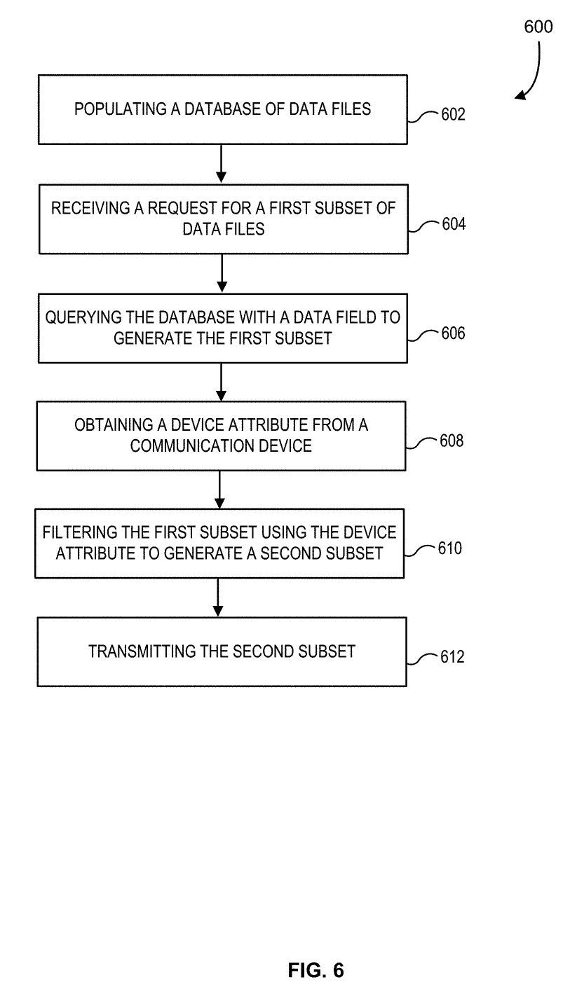

FIG. 6 depicts an illustrative flow chart for a process 600 for user-initiated imaging appointments. The process 600 is illustrated as a logical flow diagram, each operation of which represents a sequence of operations that can be implemented in either hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 600 (or any other processes described herein, or variations and/or combinations thereof) may be performed under the control of one or more computer systems configured with executable instructions and may be implemented as code (e.g., executable instructions, one or more computer programs or one or more applications). Network hardware and processing logic of scheduler 107 may execute the process blocks show in process 600, for example. The code may be stored on a computer-readable storage medium, for example, in the form of a computer program including a plurality of instructions executable by one or more processors. The computer-readable storage medium may be non-transitory.

At process block 602, a database with a plurality of data files may be populated. The database may include any number of storage devices having volatile and/or non-volatile storage on any medium. The database may be part of, or be in operative communication with, the scheduler 107, for example. The data files may include data associated with imaging facilities and/or imaging devices (e.g., names, addresses, types, etc.). The data files may have a plurality of data fields. The data fields may relate to the type of imaging data needed (e.g., a physiological location, a side of the body, a type of imaging needed, a modality, etc.). The data files may further have a plurality of attributes. The attributes may relate to characteristics of the data files (e.g., the imaging facilities), such as a location (e.g., an address), a price point, available appointment times, combinations thereof, and/or the like.

At process block 604, a request for a subset of the plurality of data files is received from a communication device. The communication device may be associated with a user, such as a patient, and may be located at a first node on a network. The network may be any of the networks described herein. The request may include input specifying at least one data field of the plurality of data fields. For example, the request may include user input from the communication device specifying a type of imaging data needed (e.g., x-ray).

At process block 606, the database may be queried with the at least one data field to generate the subset of the plurality of data files. For example, the database may be populated at process block 602 with data representative of all imaging facilities in the United States of America. The database may be searched for all imaging facilities in the United States of America that have an x-ray machine (or other necessary imaging device). The subset of the plurality of data files may include data files corresponding to imaging facilities in the United States of America that have an x-ray machine.

In some embodiments, an imaging order may be received from a computing device at a second node on the network. The computing device may be, for example, associated with a referring practitioner, such as provider system 108. The imaging order may include a plurality of specifications outlining the requirements for the imaging. The specifications may include the physiological location to be imaged, a suspected diagnosis, a modality, combinations thereof, and/or the like. The database may further be queried with the specifications of the imaging order to generate the subset of the plurality of data files.

At process block 608, a device attribute may be obtained from the communication device. In some embodiments, the device attribute may be a location associated with the communication device. For example, a server (e.g., scheduler 107) may transmit a request for a location to the communication device. The communication device may obtain its location through any available means (e.g., a Global Positioning System (GPS) device, a cell tower triangulation method, a WiFi triangulation method, etc.), and respond to the server with its location. In some embodiments, the device attribute may be transmitted by the communication device to the server along with the request for the subset of data files. In some embodiments, the device attribute may be any characteristic associated with a hardware element of the communication device. For example, the device attribute may be an Internet Protocol (IP) address associated with a communication subsystem or network interface of the communication device. In some embodiments, the device attribute may be directly or indirectly indicative of the current location, home location, work location, frequently used location, and/or any other location associated with the communication device.

At process block 610, the subset of the plurality of data files may be filtered by comparing the device attribute to the plurality of attributes of the subset to generate a filtered subset of data files. In some embodiments, this comparison may result in a differential that can be compared to a threshold differential. For example, the location of the communication device may be compared to the locations of the imaging facilities (i.e., the attributes of the imaging facilities). Distances between the location of the communication device and the locations of the imaging facilities may be calculated and compared to a threshold distance. The threshold distance may be any distance and may depend on the number of data files in the subset, the type of location, etc. For example, if there are only five imaging facilities in the subset, all five data files corresponding to the imaging facilities may be included in the filtered subset regardless of their distance from the location of the communication device. In another example, if there are five thousand imaging facilities in the subset, only those data files corresponding to imaging facilities within ten miles may be included in the filtered subset. Similarly, if the location of the communication device is in a rural area, a larger threshold distance may be used as the imaging facilities may be spread out. Conversely, if the location of the communication device is in an urban area, a smaller threshold distance may be used as the imaging facilities may be more densely located.

In some embodiments, further filters may be applied to the filtered subset of the plurality of data files. These filters may be applied to the attributes associated with the data files. For example, the filtered subset may further be filtered by coverage type, price point, available appointment dates, available appointment times, combinations thereof, and/or the like.

At process block 612, the filtered subset of the plurality of data files may be transmitted to the communication device. The filtered subset of the plurality of data files may be responsive to the request received from the communication device at process block 604. In some embodiments, the filtered subset of the plurality of data files may be displayed on the communication device. In some embodiments, a selection of a particular data file of the filtered subset may be received, such as from the communication device.

In response to the selection, any of a number of actions may be executed. For example, more information may be provided about the selected data file (e.g., some or all of the available data fields and/or attributes). In another example, a data entry may be written to the selected data file. The data entry may be, for example, an appointment at a particular imaging facility for a certain type of image. The data entry may include at least one identifier associated with the communication device. For example, the data entry may include a name of the user of the communication device, a screen name associated with the communication device, a phone number associated with the communication device, an e-mail address associated with the communication device, and/or any other identifying data. The data entry may further include the appointment type, date, and/or time.

In some embodiments, a server associated with the selected data file may be determined. For example, the selected data file may be associated with an imaging facility, and the imaging facility may host a server to execute operations associated with the imaging facility (e.g., to host a care system, a schedule, etc.). The server may be, for example, a facility system A-C 105A-105C. The data entry may be transmitted to the server. For example, if the selected data file is associated with facility A that operates facility A system 105A, scheduler 107 may transmit a data entry with data indicative of an appointment (e.g., a user or communication device identifier, a location, a date, a time, a price point, etc.) to the facility A system 105A.

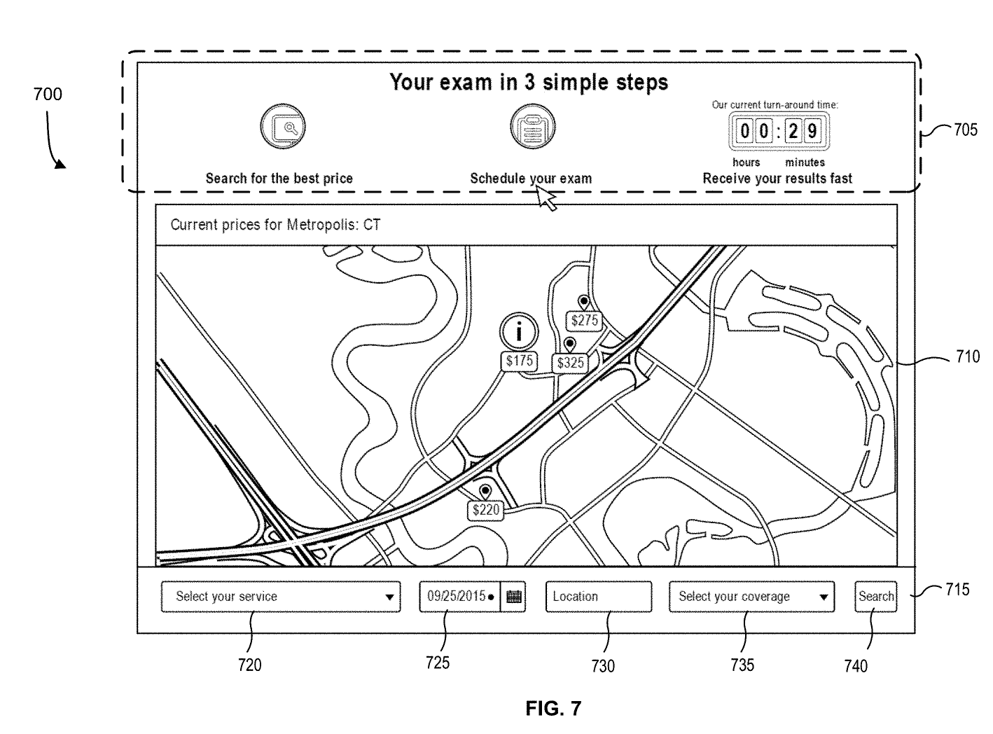

FIG. 7 illustrates an exemplary graphical interface 700 for user-initiated imaging appointments. Graphical interface 700 may be displayed on communication device 115, for example. The graphical interface 700 includes a detail panel 705, a map panel 710, and a filter panel 715. The filter panel 715 allows a user (e.g., user 120 of FIG. 1) to input the type of imaging needed via service selector 720. In this example, service selector 720 includes a drop down box providing a list of types of imaging (e.g., knee MRI).

The filter panel 715 further allows the user to input a desired date to have the imaging taken via date selector 725. Date selector 725 may provide a calendar to the user to allow the user to easily visualize and select a date. The filter panel 715 further allows the user to input a location via location selector 730. For example, the user may select a location range (e.g., within 25 miles of the user's current location). In another example, the user may input a city and state or zip code.

The filter panel 715 further allows the user to input his or her coverage via coverage selector 735. For example, the user may select whether s/he is using a third party to pay for the imaging, or whether s/he is paying for the imaging out of pocket. This selection of coverage may be important, for example, in determining the estimated cost of the imaging, which may be less if a particular imaging facility has a contracted price with certain companies.

The filter panel 715 further includes a search button 740. Search button 740 executes a search of imaging facilities according to the parameters specified in the filter panel 715. For example, search button 740 may execute filter 415 of FIG. 4. The resulting imaging facilities are displayed in map panel 710. In the example shown in FIG. 7, map panel 710 is displaying four matching imaging facilities, each indicated by an icon according to their respective location on the map. In addition to an icon at their respective locations, the estimated price of an appointment at each imaging facility is displayed according to the filter parameters provided. In one embodiment, although a imaging facility may have multiple different prices associated with different appointment times, only one price is displayed in map panel 710 to reduce clutter. The displayed price may be, for example, the lowest price for an appointment at that particular imaging facility.

In map panel 710, the imaging facility associated with the $175 estimated price has been selected. Selection of an imaging facility causes further information about that imaging facility to be displayed in detail panel 705. For example, detail panel 705 displays the current estimated turnaround time for that imaging facility (i.e., the amount of time between completion of the appointment and receipt of the imaging data). Detail panel 705 may also contain a link to schedule an imaging appointment at that imaging facility.

Selection of the link to schedule the imaging appointment at a particular imaging facility in FIG. 7 may result in the display of the exemplary graphical interface 800. Graphical interface 800 provides further information about the selected imaging facility, such as the available appointment dates and the estimated cost for appointments for the available dates. Selection of an available date may result in the display of particular appointment times and the estimated cost for appointments at the particular times. Graphical interface 800 may further provide the location of the imaging facility, a picture of the imaging facility, a description of the imaging facility, a listing of staff at the imaging facility, etc.

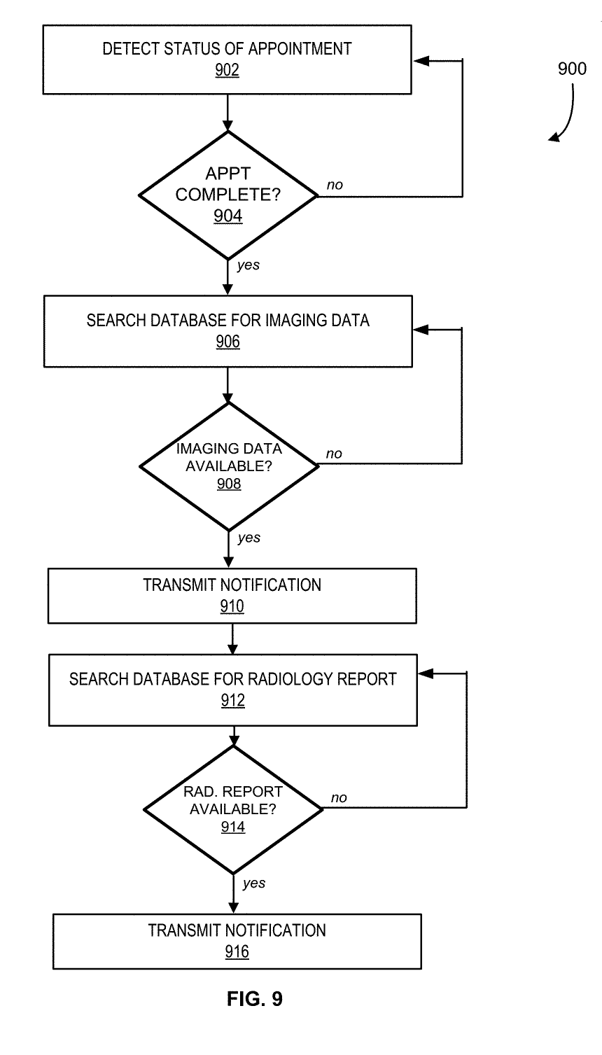

FIG. 9 depicts an illustrative flow chart for a process 900 for user notification of imaging status. The process 900 is illustrated as a logical flow diagram, each operation of which represents a sequence of operations that can be implemented in either hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 900 (or any other processes described herein, or variations and/or combinations thereof) may be performed under the control of one or more computer systems configured with executable instructions and may be implemented as code (e.g., executable instructions, one or more computer programs or one or more applications). Network hardware and processing logic of status server 117 may execute the process blocks show in process 900, for example. The code may be stored on a computer-readable storage medium, for example, in the form of a computer program including a plurality of instructions executable by one or more processors. The computer-readable storage medium may be non-transitory.

At process block 902, status of an appointment to take imaging data of a user is detected. The imaging data is generated of the user during the appointment using an imaging device. The imaging device may include X-ray device 205, MRI device 210, or CT scan device 215, for example. The imaging data may be associated with the user via an identifier. The identifier may include a name, a date of birth, a user code, an appointment code, etc.

With reference to FIG. 1, user 120 may use communication device 115 to request appointment information from user interface 116. The request may include an identifier, such as a user name and/or date of birth, user code, appointment code, etc. User interface 116 may access scheduler 107 to request the appointment information using the identifier. In response to the request, scheduler 107 looks up the appointment information using the identifier and returns the appointment information to the user interface 116, such as the appointment time and date, the imaging facility details (e.g., facility name and address), the type of imaging data (e.g., the type of imaging device, the bodily location of the imaging to be performed), the estimated cost, etc. User interface 116 may return the appointment information to the communication device 115 to be displayed to the user 120.

User interface 116 may be in operative communication with status server 117 to retrieve further data about the appointment. Status server 117 may act as a middleman between the user interface 116 and other entities involved in the collection and distribution of imaging data and status information. Status server 117 may detect and report to user interface 116 the status of an imaging appointment for user 120 using the identifier. The status of the imaging appointment may be determined by status server 117 by accessing facility interface 106, for example. Facility interface 106 knows the status of the imaging appointment based on usage of a particular imaging device. In one embodiment, ADT HL7 messages that have user acceptance and discharge data may be accessed by status server 117 to determine whether user 120 is done with a particular imaging scan. In another embodiment, ORM HL7 messages may be used to notify status server 117 when the imaging is in progress. Facility interface 106 may report the status of the appointment to status server 117 (either by request or by pushing the data), which relays it to user interface 116. User interface 116 may in turn report the status to communication device 115.

At decision block 904, it is determined whether or not the appointment is complete. Data representing completion of the appointment may be pushed by or pulled from the care system 153 to the status server 117. For example, the status server 117 may continuously or periodically mine the care system 153 for data regarding a particular appointment. The care system 153 may know that the appointment is complete by detecting discontinued usage of a imaging device (e.g., x-ray device 205, MRI device 210, or CT scan device 215). Status server 117 may relay the status of the appointment to the user interface 116 for reporting to the communication device 115. If the appointment is not complete, the method returns to process block 902 to continue to monitor the status of the appointment. If the appointment is complete, in some embodiments, a notification that the appointment is complete is generated and transmitted, such as, for example, to the user, a family member, a caregiver, a company, a referring practitioner, etc. The method then continues at process block 906.

At process block 906, a database is searched for the imaging data of the user using the identifier. For example, a database of imaging data may be searched for “John Doe”, having a date of birth of Jan. 1, 1971. In some embodiments, the database may further be searched for particular imaging data (e.g., a particular scan) using an appointment identifier, a type of imaging device, a bodily location of the imaging performed, a date of imaging, etc.

At decision block 908, it is determined whether the imaging data is available. The status server 117 may receive pushed imaging data from the care system 153 and/or pull imaging data from the care system 153. For example, the status server 117 may mine or query the care system 153 for the imaging data until the imaging data is available. If the imaging data is not available, the method returns to process block 906, where the database is further searched for the imaging data. In one embodiment, if the imaging data is not available, the database is periodically searched until the imaging data is available (e.g., every day). If the imaging data is available, the method continues at process block 910.

At process block 910, a notification that the imaging data of the user is available may be transmitted. In some embodiments, the notification may be transmitted to the user 120 using the identifier. For example, the identifier may be used to search a user information database associating the identifier with contact information of the user 120. The notification may be a message displayed in an application or on a website, and/or may be a text message, e-mail, phone call, etc. The notification may or may not provide access to the underlying imaging data of the user 120. Alternatively or additionally, in some embodiments, at process block 910, a progress indicator may be updated when the imaging data is available. The notification and/or progress indicator may be relayed from the status server 117 either directly or indirectly to the user interface 116 associated with the communication device 115.

With reference to FIG. 1, status server 117 may detect and report to user interface 116 the status of imaging data for user 120. The imaging data may be associated with the user 120 via the identifier. In one embodiment, status server 117 mines or queries care system 153 for the imaging data using the identifier. In another embodiment, care system 153 may push the imaging data, including the identifier, to status server 117. When the imaging data is available, status server 117 retrieves the imaging data, transmits a notification that the imaging data is available, and/or transmits the imaging data. The imaging data and/or the notification may be transmitted to user interface 116, which may transmit it to communication device 115.

At process block 912, a database is searched for the report file of the user 120 using the identifier. For example, a database of report files may be searched for “John Doe”, having a date of birth of Jan. 1, 1971. In some embodiments, the database may further be searched for a particular report file based on the imaging data (e.g., a particular scan) using an appointment identifier, a type of imaging device, a bodily location of the imaging performed, a date of imaging, etc. The database searched at process block 912 may be the same or a different database than the database searched at process block 906. For example, the database searched at process block 906 may be care system 153, while the database searched at process block 912 may be a database associated with image analysis system 171.

At decision block 914, it is determined whether the report file is available. If the report file is not available, the method returns to process block 912, where the database is further searched for the report file. In one embodiment, if the report file is not available, the database may be periodically searched until the report file is available (e.g., every day). In some embodiments, the database may not be searched for the report file , and the report file may instead be pushed to the status server 117. If the report file is available, the method continues at process block 916. The report file includes analysis of the imaging data of the user 120. The report file may be associated with the imaging data and the user 120 via the identifier.

At process block 916, a notification that the report file is available may be transmitted. In one embodiment, the notification is transmitted to the user 120 using the identifier. For example, the identifier may be used to search a user information database associating the identifier with contact information of the user 120. The notification may be a message displayed in an application or on a website, and/or may be a text message, e-mail, phone call, etc. The notification may or may not provide access to the underlying report file for the imaging data of the user 120. In some embodiments, access to the imaging data is provided only after the report file is available, preventing a potentially uninformed user from attempting to interpret the imaging data.

With reference to FIG. 1, status server 117 may detect and report to user interface 116 the status of the report file analyzing the imaging data of user 120. The report file may be associated with the user 120 via the identifier. In some embodiments, status server 117 mines care system 153 for the report file using the identifier. In some embodiments, care system 153 pushes the report file , including the identifier, to status server 117. In one example, OIU HL7 messages are results messages that may indicate that a report file is completed. In either embodiment, care system 153 receives the report file from an image analysis system 171. In still another embodiment, status server 117 receives the report file , including the identifier, directly from image analysis system 171. When the report file is available, status server 117 may transmit a notification that the report file is available and/or transmit the report file to user interface 116, which may transmit it to communication device 115.

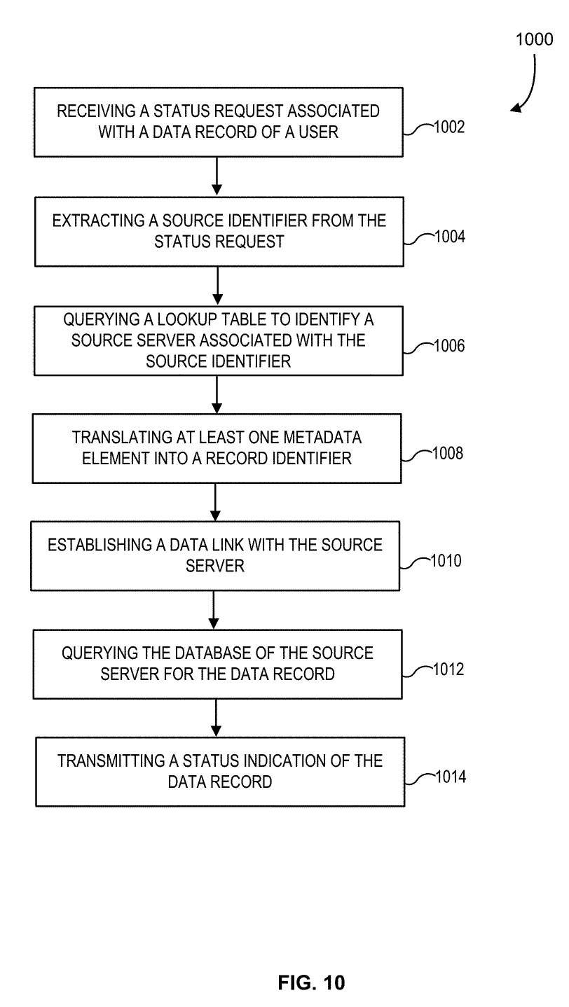

FIG. 10 depicts an illustrative flow chart for a process 1000 for user notification of imaging status. The process 1000 is illustrated as a logical flow diagram, each operation of which represents a sequence of operations that can be implemented in either hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 1000 (or any other processes described herein, or variations and/or combinations thereof) may be performed under the control of one or more computer systems configured with executable instructions and may be implemented as code (e.g., executable instructions, one or more computer programs or one or more applications). Network hardware and processing logic of status server 117 may execute the process blocks show in process 1000, for example. The code may be stored on a computer-readable storage medium, for example, in the form of a computer program including a plurality of instructions executable by one or more processors. The computer-readable storage medium may be non-transitory.

At process block 1002, a status request is received from a communication device at a first node on a network. The communication device may be any of the communication devices described herein, and the network may be any of the networks described herein. A node, as used herein, may refer to a communication point on the network. The status request may be associated with a data record of a user. The data record of the user may include any of the data described herein, such as imaging data (also referred to herein as one or more “physiological images”), report files, data reports analyzing a physiological image, EMRs, orders, combinations thereof, and the like. The status request may request the status of the data record (e.g., not started, in progress, completed, transmitted, etc.). The status request may include a source identifier (e.g., a name of an imaging facility, name or type of imaging device, etc.) and a plurality of metadata elements related to the data record (e.g., name of user, birthdate of user, type of imaging, physiological location of imaging, etc.).

At process block 1004, the source identifier may be extracted from the status request. For example, the status request may be parsed into categories and/or fields, and the data corresponding to the source identifier may be identified. At process block 1006, a lookup table may be queried to identify a source server associated with the source identifier. The lookup table may include a plurality of data elements, such as a listing of source identifiers (e.g., names of imaging facilities) and their corresponding source servers (e.g., IP addresses of the servers of the imaging facilities). The source servers may be, for example, facility systems 105A-C, provider system 108, image analysis system 171, etc. The source server may populate a database with a plurality of data records for a plurality of users. For example, a source server associated with an imaging facility may populate a database with physiological images taken at that imaging facility. The physiological images may be, for example, high resolution or compressed images of body sites targeted by the imaging.

At process block 1008, at least one metadata element of the plurality of metadata elements may be translated into a record identifier. In some embodiments, the record identifier may be unique for a given individual. In some embodiments, the record identifier may be standardized. For example, if the plurality of metadata elements includes a user's name (John A. Doe) and date of birth (Jan. 1, 1975), a record identifier may be formulated as DOE_JOHN_A_1975_01_01. In some embodiments, the record identifier may be formulated by hashing or applying an algorithm to at least one metadata element. In some embodiments, the record identifier may be the same as the metadata element (e.g., both may be “John Doe”).

At process block 1010, a data link may be established with the source server at a second node on the network. The data link may be established, for example, by utilizing communication subsystems and/or network interfaces to transmit, receive, and/or exchange data over the network. In some embodiments, the second node is at a different location on the network than the first node.

At process block 1012, the database of the source server may be queried for the data record of the user using the record identifier. For example, the plurality of data records for the plurality of users may be searched for “DOE_JOHN_A_1975_01_01”. In some embodiments, the database of the source server may be queried directly using the metadata element. The source server may return one or more data records corresponding to the record identifier. In some embodiments, these data records may be filtered by further metadata elements, such as modality, date of imaging, physiological location of imaging, etc.).

The data records responsive to the query may include status indications (e.g., not started, in progress, completed, imaging available, report file available, etc.). At process block 1014, the status indication associated with the data record of the user may be transmitted over the network. In some embodiments, the status indication may be transmitted to the communication device at the first node on the network. In some embodiments, the status indication may be transmitted to a computing device at a third node on the network (e.g., provider system 108). The third node may be separately located from the first node and the second node in some embodiments. In some embodiments, the physiological image may be transmitted over the network.

In some embodiments, a datastore at a report server (e.g., image analysis system 171 and/or distribution server 190) may be queried for a data report (also referred to herein as a “report file”). The data report may analyze the physiological image in the data record. The datastore may be queried using the record identifier. The report server may be located at a fourth node on the network, which may located at a same or different location than the first, second and third nodes described herein.

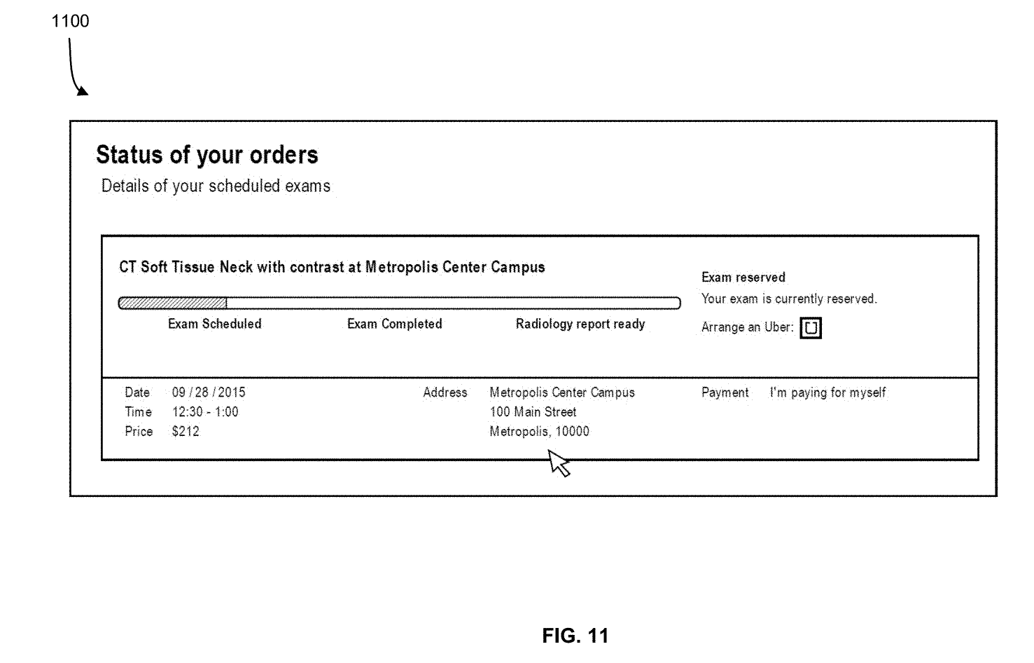

FIG. 11 illustrates a graphical interface 1100 for user notification of imaging status. Graphical interface 1100 may be displayed on communication device 115, for example. Graphical interface 1100 displays details of the imaging, such as the type of imaging, the imaging facility, the date of the imaging, the time of the imaging, the estimated cost of the imaging, the location of the imaging facility, and the coverage information (e.g., whether the user or a third party is paying for the appointment).

Graphical interface 1100 further includes a status bar that shows the current status of the appointment. In the example shown in FIG. 11, the appointment has been scheduled. The status bar would be updated once the appointment has been completed and when the report file is ready. Although not shown in FIG. 11, the status bar may further indicate when the imaging data is available. In some embodiments, graphical interface 900 may further include links to the imaging data and/or the report file, once they are available.

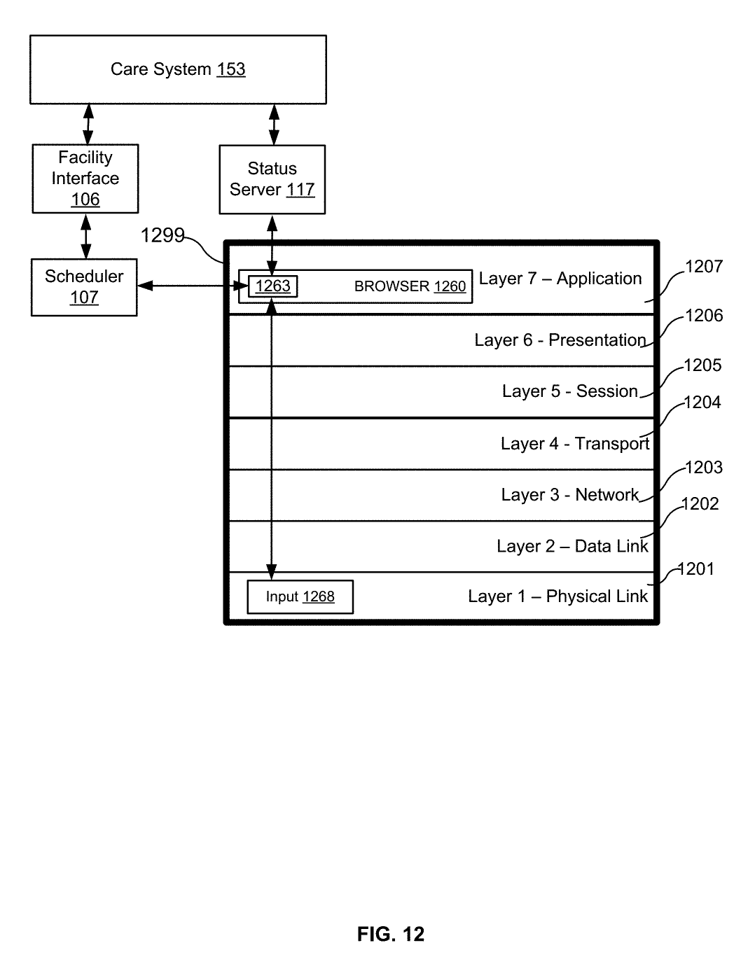

FIG. 12 is a block diagram of a protocol stack 1299 that may be implemented by the communication device 115 in accordance with some embodiments. The communication device 115 may implement the protocol stack to communicate with any of the other systems described herein, such as the scheduler 107 and the status server 117. The protocol stack 1299 may include one or more of seven layers: an application layer 1207, a presentation layer 1206, a session layer 1205, a transport layer 1204, a network layer 1203, a data link layer 1202, and a physical link layer 1201. Together, these seven layers may represent a model, such as an Open Systems Interconnection (OSI) model. The OSI model of FIG. 12 may characterize the communication functions of the described systems. Although shown and described as having seven layers, it is contemplated that the protocol stack 1299 may include more or fewer layers to perform less, the same, or additional functions.

According to the OSI model, the application layer 1207 may interact with a user (e.g., via receiving user inputs and presenting outputs) and software applications implementing a communication component. The application layer 1207 may synchronize communication between systems and determine resource availability. The application layer 1207 may be application-specific, in that the specific functions dependent on the particular application being executed by the communication device 115.

For example, the application layer 1207 may execute a browser 1060 (e.g., Google Chrome) which in turn may execute the processes (e.g., of process 500, 600, 900 and/or 1000) of the disclosure with the assistance of an extension or interface 1263. Browser 1260 and extension 1263 may be executed entirely at the application layer 1207. This allows for the communication device 115 to request and schedule appointments via scheduler 107 in communication with facilities via facility interface 106. This may also allow for the communication device 115 to notified of the status of imaging records via status server 117 and view imaging records (e.g., from care system 153) in a zero footprint system in that only a browser as an application and corresponding extension are required to execute the disclosed processes. In implementations that include a zero footprint system, any of the records and/or data described herein may be stored in a memory of a server, for example. The browser and corresponding extension may then access this content stored in the memory of the server.

The presentation layer 1206 may translate between application and network formats. Various applications and networks may implement different syntaxes and semantics. Thus, the presentation layer 1206 may transform data from the network into a form that the application accepts. The presentation layer 1206 may also format and encrypt data from the application to be sent on a network.

The session layer 1205 may control connections between the systems and other devices and/or servers, as described herein. The session layer 1205 may establish the connections, manage the connections, and terminate the connections used to communicate between the devices.

The transport layer 1204 may provide techniques for performing quality of service functions during transfers of data between devices. The transport layer 1204 may provide error control. For example, the transport layer 1204 may keep track of data being transmitted and transmit any communications that fail. In addition, the transport layer 1204 may provide an acknowledgment of successful data transmission and send the next data to be transmitted in a synchronous fashion if no errors occurred.

The network layer 1203 may provide the means of transferring the data to and from the systems over a network. The source node and destination node of the systems may each have an address which permits the other to transfer data to it by providing the address with the data. The network layer 1203 may also perform routing functions that allow it to a determine a path between the source node and destination node, possibly through other nodes.

The data link layer 1202 may define and provide the link between a directly and physically connected source node and destination node. The data link layer 1202 may further detect and correct errors occurring at the physical link layer 1201. In some embodiments, the data link layer 1202 may include two sublayers: a media access control (MAC) layer that may control how devices in the network gain access to data and gain permission to transmit it, and a logical link control (LLC) layer that may identify network layer 1203 protocols and encapsulate them.

The physical link layer 1201 may include one or more input devices 1268. The input devices 1268 may include, for example, a keyboard, a mouse, a trackpad, a trackball, a touchscreen display, and/or any other device capable of receiving user input. The physical link layer 1201 may define the electrical and physical specifications of the data. The physical link layer 1201 may provide a physical medium for storing unstructured raw data to be transmitted and received.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. The computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as performing or being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined encoder-decoder (CODEC).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

What is claimed is:

1. A device comprising:
a processor; and
a memory coupled to the processor, the memory storing instructions which when executed by the processor, cause the device to perform operations including:
receiving, from a communication device at a first node on a network, a status request associated with a data record of a user, wherein:
the data record includes a physiological image, and
the status request includes a source identifier and a plurality of metadata elements related to the physiological image;
extracting the source identifier from the status request;
querying a lookup table to identify a source server associated with the source identifier, wherein the source server populates a database with a plurality of data records of a plurality of users;
translating at least one metadata element of the plurality of metadata elements into a record identifier;
establishing a data link with the source server at a second node on the network;
querying the database of the source server for the data record of the user using the record identifier; and
transmitting a status indication of the data record of the user over the network.

2. The device of claim 1, wherein the status indication is transmitted to the communication device at the first node on the network.

3. The device of claim 1, wherein the status indication is transmitted to a computing device at a third node on the network.

4. The device of claim 1, wherein the data record further includes a data report analyzing the physiological image.

5. The device of claim 1, wherein the operations further include:
querying a datastore at a report server for a data report analyzing the physiological image, wherein the datastore is queried using the record identifier, and wherein the report server is at a third node on the network.

6. The device of claim 1, wherein the status indication is transmitted when the data record of the user is located in the database of the source server.

7. The device of claim 1, wherein the operations further include:
transmitting the physiological image over the network.

8. A computer-program product tangibly embodied in a non-transitory machine-readable storage medium of a computing device, including instructions that, when executed by one or more processor, cause the one or more processors to:
receive, from a communication device at a first node on a network, a status request associated with a data record of a user, wherein:
the data record includes a physiological image, and
the status request includes a source identifier and a plurality of metadata elements related to the physiological image;
extract the source identifier from the status request;
query a lookup table to identify a source server associated with the source identifier, wherein the source server populates a database with a plurality of data records of a plurality of users;
translate at least one metadata element of the plurality of metadata elements into a record identifier;
establish a data link with the source server at a second node on the network;
query the database of the source server for the data record of the user using the record identifier; and
transmit a status indication of the data record of the user over the network.

9. The computer-program product of claim 8, wherein the status indication is transmitted to the communication device at the first node on the network.

10. The computer-program product of claim 8, wherein the status indication is transmitted to a device at a third node on the network.

11. The computer-program product of claim 8, wherein the data record further includes a data report analyzing the physiological image.

12. The computer-program product of claim 8, wherein the instructions further cause the one or more processors to:
query a datastore at a report server for a data report analyzing the physiological image, wherein the datastore is queried using the record identifier, and wherein the report server is at a third node on the network.

13. The computer-program product of claim 8, wherein the status indication is transmitted when the data record of the user is located in the database of the source server.

14. The computer-program product of claim 8, wherein the instructions further cause the one or more processors to:
transmit the physiological image over the network.

15. A computer-implemented method comprising:
receiving, from a communication device at a first node on a network, a status request associated with a data record of a user, wherein:
the data record includes a physiological image, and
the status request includes a source identifier and a plurality of metadata elements related to the physiological image;
extracting the source identifier from the status request;
querying a lookup table to identify a source server associated with the source identifier, wherein the source server populates a database with a plurality of data records of a plurality of users;
translating at least one metadata element of the plurality of metadata elements into a record identifier;
establishing a data link with the source server at a second node on the network;
querying the database of the source server for the data record of the user using the record identifier; and
transmitting a status indication of the data record of the user over the network.

16. The computer-implemented method of claim 15, wherein the status indication is transmitted to the communication device at the first node on the network.

17. The computer-implemented method of claim 15, wherein the status indication is transmitted to a computing device at a third node on the network.

18. The computer-implemented method of claim 15, wherein the data record further includes a data report analyzing the physiological image.

19. The computer-implemented method of claim 15, further comprising:
querying a datastore at a report server for a data report analyzing the physiological image, wherein the datastore is queried using the record identifier, and wherein the report server is at a third node on the network.

20. The computer-implemented method of claim 15, further comprising:
transmitting the physiological image over the network.
